(19) United States
(12) Patent Application Publication
(10) Pub. No.: US 2026/0235225 A1
(43) Pub. Date: Aug. 13, 2026

(54) VALVE STRUCTURE

(71) Applicants: Meng-Ta Chung, Hukou Township (TW); Xin Xiang Da Ltd., Hukou Township (TW)

(72) Inventor: Meng-Ta Chung, Hukou Township (TW)

(21) Appl. No.: 19/532,799

(22) Filed: Feb. 6, 2026

(30) Foreign Application Priority Data
Feb. 7, 2025 (TW) 114104697

(51) Int. Cl. F16K 31/122; F16K 1/36

(52) U.S. Cl. CPC F16K 31/1221; F16K 1/36

(57) ABSTRACT

A valve structure includes a housing assembly, a driving assembly, and a linkage assembly. A flow channel of the housing assembly extends along a first direction. The driving assembly is movable arranged in the housing assembly along a second direction perpendicular to the first direction and has a driving portion inclined relative to the second direction. A link of the linkage assembly includes a first end and a second end opposite to each other, and a spherical protrusion located between the first end and the second end. The first end is movably accommodated in the driving portion. The spherical protrusion is rotatably accommodated in the housing assembly. The second end extends into the flow channel and is connected to a sealing member of the linkage assembly. When the driving assembly moves along the second direction, the driving portion drives the sealing member to open or close the flow channel.

### CROSS-REFERENCE TO RELATED APPLICATION

This non-provisional application claims priority under 35 U.S.C. § 119(a) to Patent Application No. 114104697 filed in Taiwan, R.O.C. on Feb. 7, 2025, the entire contents of which are hereby incorporated by reference.

### BACKGROUND

### Technical Field

The present disclosure relates to a valve structure.

### Related Art

The valve structure is a common structure that can be controlled to open or close by applying a driving force, so as to allow or prohibit the passage of fluid.

Due to the design of internal flow channels or structures, most existing valve structures suffer from drawbacks such as high fluid flow resistance, high driving force requirements, poor leak-proof effects, excessive operating noise, or insufficient service life, and therefore need to be improved.

### SUMMARY

This application provides a valve structure, including a housing assembly, a driving assembly, and a linkage assembly. The housing assembly has an internal space, a flow channel, a fluid inlet, a fluid outlet, and a valve cover. The flow channel extends along a first direction and is in communication with the internal space. The fluid inlet extends through the housing assembly and is joined to one end of the flow channel. The fluid outlet extends through the housing assembly and is joined to the other end of the flow channel. The valve cover is located between the internal space and the flow channel and has an accommodating groove. The driving assembly is movably arranged in the internal space of the housing assembly along a second direction perpendicular to the first direction. The driving assembly has a driving portion, and an included angle is formed between an extension direction of the driving portion and the second direction. The linkage assembly includes a link and a sealing member. The link includes a first end and a second end opposite to each other, and a spherical protrusion located between the first end and the second end. The first end is movably accommodated in the driving portion. The spherical protrusion is rotatably accommodated in the accommodating groove. The second end extends into the flow channel through the valve cover. The sealing member is sleeved on the second end of the link. When the driving assembly moves along the second direction, the driving assembly drives, through the driving portion, the first end of the link to move in the first direction, and the second end is configured to drive the sealing member to open or close the flow channel.

In some embodiments, the first end of the link is spherical.

In some embodiments, the housing assembly includes a valve body, the fluid inlet and the fluid outlet extend through the valve body, and the flow channel is located in the valve body. The valve body further includes a valve opening, the valve opening is in communication with the flow channel, and the valve cover covers the valve opening. The sealing member includes a first portion and a second portion that are connected to each other. The first portion is located between the valve cover and the valve body, the second portion is deformable relative to the first portion, and the second end of the link passes through the first portion and is inserted into the second portion.

In some embodiments, the second portion of the sealing member includes a first groove, a second groove, and a spacing wall. The first groove is formed along the second direction, the second groove is formed along the first direction, and the spacing wall is located between the first groove and the second groove.

In some embodiments, the first groove has a first inner surface, the second groove has a second inner surface, the first inner surface becomes circular around the second direction, and the second inner surface becomes circular around the first direction.

In some embodiments, the second portion has a part of the second groove formed into a cylinder around the first direction, and an outer circumferential surface of the part of the second portion includes a first notch and a second notch. In the second direction, the first notch is closer to the valve cover than the second notch, the first notch has a first groove width in the first direction, the second notch has a second groove width in the first direction, and the first groove width is not equal to the second groove width.

In some embodiments, the first groove width is less than the second groove width.

In some embodiments, the second portion of the sealing member further includes a first flange, a second flange, and a ring groove. The ring groove is located on an end surface of a part of the second portion having the second groove. The ring groove surrounds the second groove. The first flange and the second flange are respectively located on two opposite ends of the ring groove in the second direction.

In some embodiments, a first included angle is formed at a joint between the first flange and the ring groove, a second included angle is formed at a joint between the second flange and the ring groove, and the first included angle is greater than the second included angle.

In some embodiments, the second flange includes a joining section and an extending section. The joining section is joined to the ring groove, and a length of the extending section overlapping the ring groove in the second direction is greater than 50% of a length of the ring groove in the second direction.

In some embodiments, the first portion of the sealing member has a through hole and an upper surface and a lower surface that are opposite to each other. The lower surface is a plane, and the upper surface has an arc-shaped convex portion and an annular concave portion. The arc-shaped convex portion surrounds the through hole, and the annular concave portion surrounds the arc-shaped convex portion.

In some embodiments, the link further includes a notch and a first stop portion. The notch is located on a side of the spherical protrusion, and the first stop portion is located on a side of the notch. The valve cover includes a first component and a second component. The first component has a second stop portion, and positions of the first stop portion and the second stop portion overlap in the first direction.

In some embodiments, the driving assembly further includes a relief portion, and the relief portion is joined to the driving portion and extends along the first direction.

In some embodiments, an included angle is formed between the extension direction of the driving portion of the driving assembly and each of the first direction and the second direction.

In some embodiments, the driving portion of the driving assembly extends along the first direction.

In some embodiments, the valve body includes an inlet pipe portion, a body portion, and an outlet pipe portion that are joined in sequence. The inlet pipe portion has a first channel, the body portion has a main flow channel space, and a position where the main flow channel space is joined to the first channel is in a curved and expanded shape.

In some embodiments, the second portion of the sealing member further includes an inner ring groove provided on the second inner surface of the second groove.

In some embodiments, the second portion of the sealing member further includes a reinforcing rib. The reinforcing rib is arranged in the second notch.

### BRIEF DESCRIPTION OF THE DRAWINGS

FIG. 1 is a schematic diagram of a three-dimensional appearance of an embodiment of a valve structure of this application;

FIG. 2 is a schematic cross-sectional view of a driving member of an embodiment of a valve structure of this application in a first position;

FIG. 3 is a partial enlarged view of a circled area 3 in FIG. 2;

FIG. 4 is a schematic cross-sectional view of a driving member of an embodiment of a valve structure of this application in a second position;

FIG. 5 is a schematic diagram of an embodiment of a link of a valve structure of this application;

FIG. 6 is a schematic diagram of an appearance of an embodiment of a sealing member of a valve structure of this application;

FIG. 7 is a schematic diagram of an embodiment of a sealing member of a valve structure of this application from another perspective;

FIG. 8 is a schematic cross-sectional view 1 of an embodiment of a sealing member of a valve structure of this application;

FIG. 9 is a schematic cross-sectional view 2 of an embodiment of a sealing member of a valve structure of this application;

FIG. 10 is a schematic diagram of a three-dimensional appearance of an embodiment of a valve body of a valve structure of this application;

FIG. 11 is a schematic cross-sectional view of an embodiment of a valve body of a valve structure of this application;

FIG. 12 is a schematic cross-sectional view of a driving member of another embodiment of a valve structure of this application in a first position;

FIG. 13 is a schematic cross-sectional view of a driving member of another embodiment of a valve structure of this application in a second position;

FIG. 14 is a schematic diagram of another embodiment of a link of a valve structure of this application;

FIG. 15 is a three-dimensional schematic cross-sectional view of an embodiment of a first component of a valve cover of this application;

FIG. 16 is a three-dimensional schematic cross-sectional view of an embodiment of a second component of a valve cover of this application;

FIG. 17 is a schematic diagram of an appearance of an embodiment of a first component of a valve cover of this application;

FIG. 18 is a schematic diagram of an embodiment in which a driving portion of a valve structure of this application extends along a first direction and a linkage assembly closes a flow channel; and

FIG. 19 is a schematic diagram of an embodiment in which a driving portion of a valve structure of this application extends along a first direction and a linkage assembly is open relative to a flow channel.

### DETAILED DESCRIPTION

Before this application is described in detail in various embodiments, it is to be noted that in the following description, the figures of this application are merely illustrative, and are not necessarily drawn to scale, and all details are not necessarily shown in the figures.

The use of a measure word of “a” or “one” used for elements and components described throughout the present disclosure is merely for convenience of use and to provide a general meaning of the scope of the present invention. In the present invention, the measure word needs to be interpreted as including one or at least one. The singular concept also includes the plural, unless it is obviously meant to mean otherwise. In addition, terms such as “first” and “second” are merely used for description, and cannot be understood as indicating or implying relative importance or implicitly indicating a quantity of indicated technical features. Therefore, a feature defined by “first” or “second” may explicitly or implicitly include one or more features. In the description of this application, unless otherwise stated, “a plurality of” means two or more than two.

In the description of this application, it should be understood that orientation or position relationships indicated by the terms such as “center”, “longitudinal”, “transverse”, “up”, “down”, “front”, “rear”, “left”, “right”, “vertical”, “horizontal”, “top”, “bottom”, “inside”, and “outside” are based on orientation or position relationships shown in the accompanying drawings, and are used only for ease and brevity of description of this application, rather than indicating or implying that the mentioned apparatus or element needs to have a particular orientation or needs to be constructed and operated in a particular orientation. Therefore, the terms should not be construed as a limitation on this application.

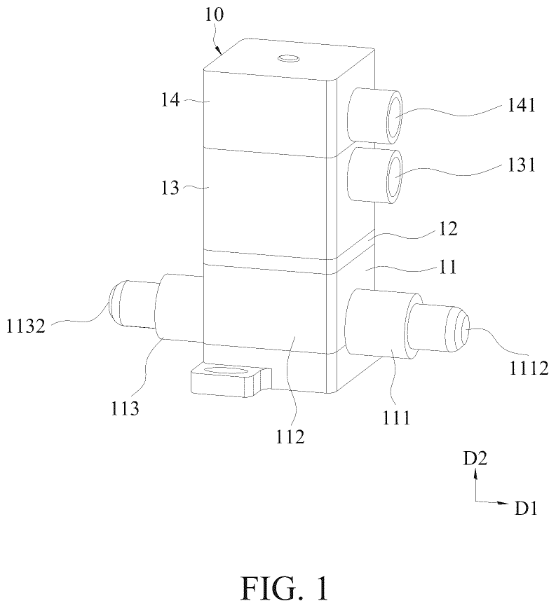

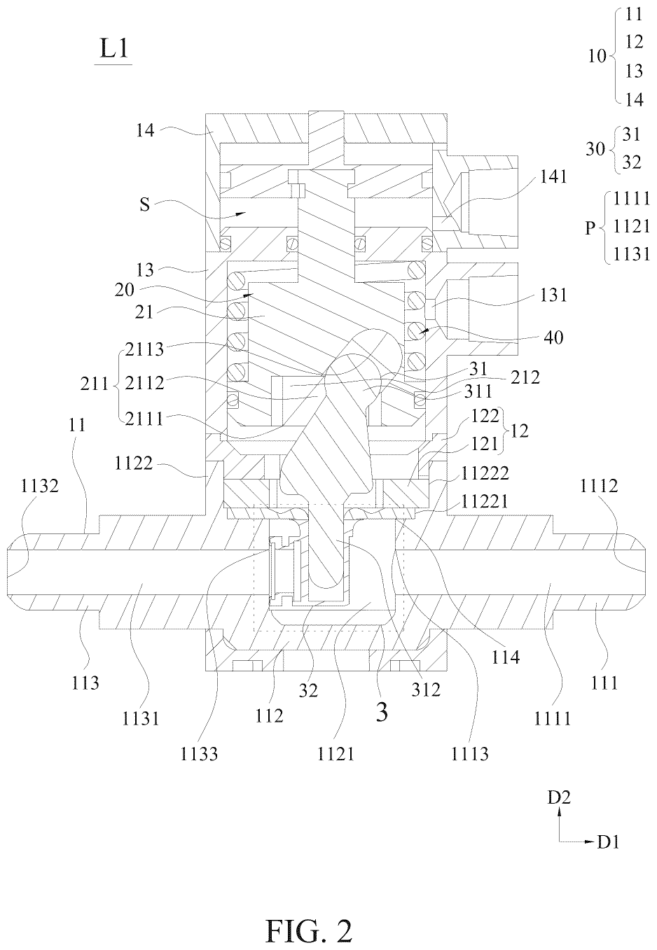

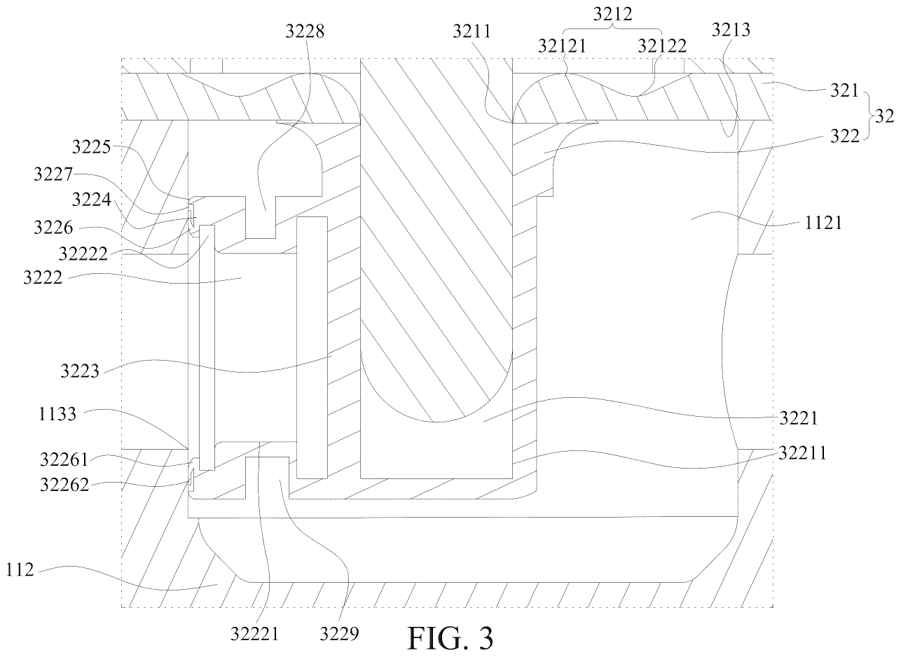

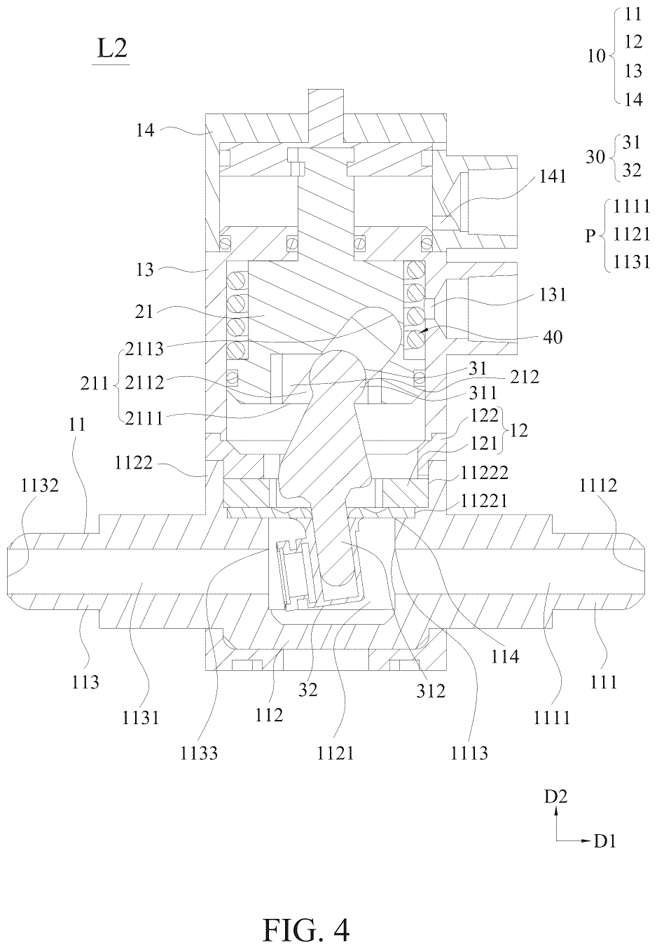

Refer to FIG. 1 to FIG. 4. FIG. 1 is a schematic diagram of a three-dimensional appearance of an embodiment of a valve structure of this application; FIG. 2 is a schematic cross-sectional view of a driving member of an embodiment of a valve structure of this application in a first position; FIG. 3 is a partial enlarged view of a circled area 3 in FIG. 2; and FIG. 4 is a schematic cross-sectional view of a driving member of an embodiment of a valve structure of this application in a second position. This application provides a valve structure, which is a fluid valve structure that allows fluid flow and can control opening and closing. The valve structure includes a housing assembly 10, a driving assembly 20, and a linkage assembly 30. The housing assembly 10 has an internal space S, a flow channel P, a fluid inlet 1112, a fluid outlet 1132, and a valve cover 12. The flow channel P extends along a first direction D1 and is in communication with the internal space S. The fluid inlet 1112 extends through the housing assembly 10 and is joined to one end of the flow channel P. The fluid outlet 1132 extends through the housing assembly 10 and is joined to the other end of the flow channel P. The valve cover 12 is located between the internal space S and the flow channel P and has an accommodating groove. The driving assembly 20 is movably arranged in the internal space S of the housing assembly 10 along a second direction D2 perpendicular to the first direction D1. The driving assembly 20 has a driving portion 211, and an included angle is formed between an extension direction of the driving portion 211 and the second direction D2. The linkage assembly 30 includes a link 31 and a sealing member 32. The link 31 includes a first end 311 and a second end 312 opposite to each other, and a spherical protrusion 3131 located between the first end 311 and the second end 312. The first end 311 is movably accommodated in the driving portion 211. The spherical protrusion 3131 is rotatably accommodated in the accommodating groove. The second end 312 extends into the flow channel P through the valve cover 12. The sealing member 32 is sleeved on the second end 312 of the link 31. When the driving assembly 20 moves along the second direction D2, the driving assembly 20 drives, through the driving portion 211, the first end 311 of the link 31 to move in the first direction D1, and the second end 312 is configured to drive the sealing member 32 to open or close the flow channel P.

Accordingly, a labor-saving and durable valve structure is provided.

Refer to FIG. 1 to FIG. 4. The housing assembly 10 provides a space for the driving assembly 20 to move and a space for a fluid to pass through. In some embodiments, the housing assembly 10 includes a valve body 11, the valve cover 12, a first housing 13, and a second housing 14. The valve body 11 has the flow channel P. The valve cover 12 is arranged on the valve body 11. The internal space S is located in the first housing 13 and the second housing 14. The first housing 13 is mounted to the valve cover 12. The second housing 14 is mounted to the first housing 13.

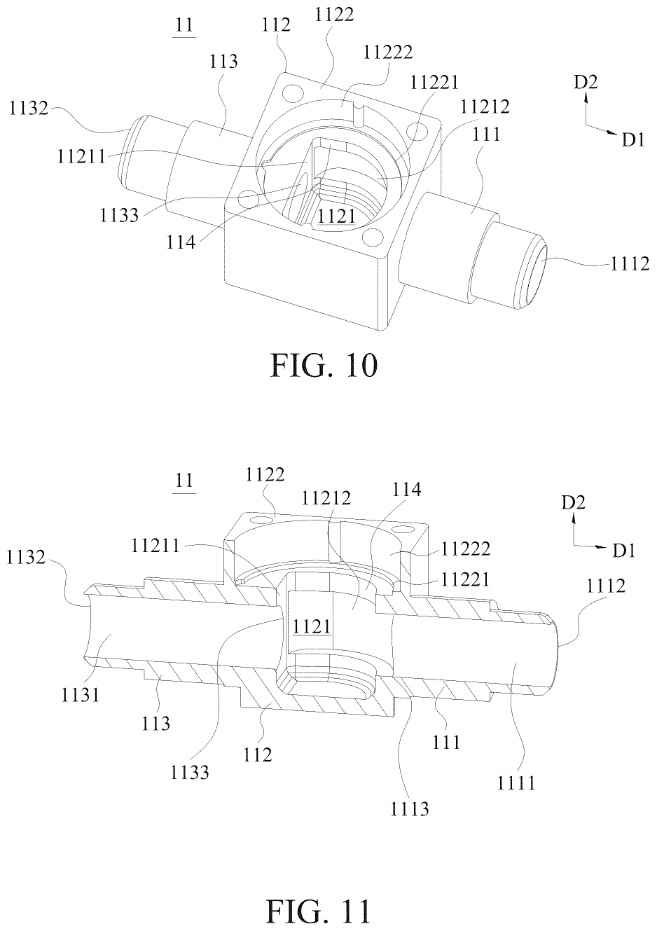

Refer to FIG. 1 to FIG. 4 in conjunction with FIG. 10 and FIG. 11. FIG. 10 is a schematic diagram of a three-dimensional appearance of an embodiment of a valve body of a valve structure of this application; and FIG. 11 is a schematic cross-sectional view of an embodiment of a valve body of a valve structure of this application. In some embodiments, the valve body 11 includes an inlet pipe portion 111, a body portion 112, and an outlet pipe portion 113 that are joined in sequence. The inlet pipe portion 111 has a first channel 1111. The body portion 112 has a main flow channel space 1121. The outlet pipe portion 113 has a second channel 1131. The first channel 1111, the main flow channel space 1121, and the second channel 1131 are in communication with each other to form the flow channel P. The inlet pipe portion 111 has the fluid inlet 1112 and a valve inlet 1113. The fluid inlet 1112 is located on an end of the first channel 1111 away from the body portion 112. The valve inlet 1113 is located on an end of the first channel 1111 joined to the main flow channel space 1121. The outlet pipe portion 113 has the fluid outlet 1132 and a valve outlet 1133. The fluid outlet 1132 is located on an end of the second channel 1131 away from the body portion 112. The valve outlet 1133 is located on an end of the second channel 1131 joined to the main flow channel space 1121. The fluid can enter the valve body 11 through the fluid inlet 1112 of the valve body 11, then pass through the first channel 1111, the valve inlet 1113, the main flow channel space 1121, the valve outlet 1133, and the second channel 1131 in sequence, and then flow out of the fluid outlet 1132. In addition, the main flow channel space 1121 provides a space for the sealing member 32 of the linkage assembly 30 to swing to open or close the valve outlet 1133.

Refer to FIG. 1 to FIG. 4 in conjunction with FIG. 10 and FIG. 11. In some embodiments, the valve body 11 has a valve opening 114. The valve opening 114 is located in the body portion 112 and is in communication with the main flow channel space 1121. In these embodiments, the valve cover 12 can cover the valve opening 114 and can cooperate with the sealing member 32 of the linkage assembly 30 to close the valve opening 114.

Refer to FIG. 1 to FIG. 4. In some embodiments, the driving assembly 20 includes a driving member 21. The driving member 21 is movably accommodated in the internal space S along the second direction D2, and the driving member 21 has the driving portion 211. The driving portion 211 is an inclined channel at an angle to each of the first direction D1 and the second direction D2. Herein, the driving portion 211 has an opening 2111, an inner surface 2112, and a bottom surface 2113. The inner surface 2112 and the bottom surface 2113 of the channel-type driving portion 211 are both arc surfaces. In these embodiments, the opening 2111 of the driving portion 211 is open toward the valve cover 12, and an included angle is formed between the extension direction from the opening 2111 to the bottom surface 2113 and each of the first direction D1 and the second direction D2. In other words, the driving portion 211 is inclined relative to the first direction D1 and the second direction D2, and the opening 2111 and the bottom surface 2113 of the driving portion 211 are located in different positions in the first direction D1.

In some embodiments, the driving member 21 of the driving assembly 20 further includes a relief portion 212. The relief portion 212 is joined to the opening 2111 of the driving portion 211 and extends along the first direction D1. In these embodiments, the relief portion 212 is a groove, thereby providing a smoother swing displacement space for the link 31 of the linkage assembly 30, and improving the smooth operation of the valve structure.

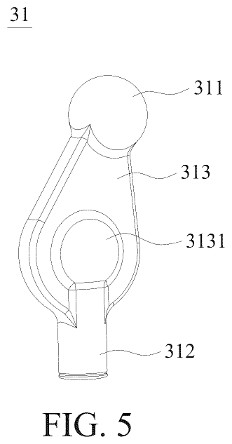

Refer to FIG. 1 to FIG. 4 in conjunction with FIG. 5. FIG. 5 is a schematic diagram of an embodiment of a link of a valve structure of this application. In some embodiments, the first end 311 of the link 31 is of a spherical structure, and the second end 312 of the link 31 is of a cylindrical structure. In these embodiments, the link 31 further includes a connecting portion 313. The connecting portion 313 has a sheet structure. The spherical protrusion 3131 protrudes from two opposite sides of the connecting portion 313. In addition, the connecting portion 313 of the link 31 extends in thickness along a thickness direction. The thickness direction is perpendicular to the two opposite sides of the connecting portion 313, and an axial direction of the second end 312 of the cylindrical structure is perpendicular to the thickness direction of the connecting portion 313. Herein, for the overall configuration of the link 31, an overall length of the link 31 may be changed by changing a length of the first end 311. When the length of the link 31 is changed, an acting force applied by the link 31 to drive the sealing member 32 to seal the valve outlet 1133 can be changed. In some embodiments, the length of the link 31 is increased when the internal space S allows, so that the acting force for the link 31 to drive the sealing member 32 to seal the valve outlet 1133 increases correspondingly. In this way, the driving force for driving the driving assembly 20 to move may be reduced, to achieve the purpose of saving labor.

In these embodiments, the accommodating groove of the valve cover 12 corresponding to the spherical protrusion 3131 is spherical. Herein, the first end 311 of the link 31 extends into the driving portion 211 through the opening 2111 of the driving portion 211. The second end 312 of the link 31 passes through the valve cover 12 and extends into the main flow channel space 1121 of the valve body 11. The sealing member 32 is sleeved on the second end 312 of the link 31 in the main flow channel space 1121. The spherical protrusion 3131 of the link 31 is rotatably accommodated in the accommodating groove. Accordingly, when the driving member 21 of the driving assembly 20 moves along the second direction D2, the driving member 21 is sleeved on the first end 311 of the link 31 through the driving portion 211 to move. When the driving member 21 moves, the first end 311 of the link 31 is in different positions relative to the driving portion 211, thereby driving the first end 311 of the link 31 to change the position along the first direction D1 and further form a swing.

Refer to FIG. 1 to FIG. 5. Specifically, the driving member 21 of the driving assembly 20 may move between a first position L1 and a second position L2 along the second direction D2, and the driving member 21 is closer to the valve body 11 in the first position L1 than in the second position L2. Refer to FIG. 2. In the first position L1, the first end 311 of the link 31 is close to the bottom surface 2113 of the driving portion 211. The second end 312 of the link 31 and the sealing member 32 thereon are close to the valve outlet 1133 of the valve body 11. The sealing member 32 closes the valve outlet 1133, so that the flow channel P of the valve body 11 enters a closed state (that is, the fluid cannot freely pass through the valve body 11).

Refer to FIG. 1 to FIG. 5. In the second position L2, the driving portion 211 of the driving member 21 is changed to cover the first end 311 of the link 31 near the opening 2111. However, since the opening 2111 and the bottom surface 2113 of the driving portion 211 are located in different positions in the first direction D1, the first end 311 of the link 31 located in the driving portion 211 is driven to change its position in the first direction D1. In addition, the link 31 rotates around the spherical protrusion 3131 as the center of a circle, and the second end 312 swings synchronously. Accordingly, while the driving member 21 drives the link 31 to swing, the sealing member 32 located on the second end 312 of the link 31 can change the open or closed state relative to the valve outlet 1133 of the valve body 11, thereby achieving the purpose of opening and closing the valve body 11 to control the fluid.

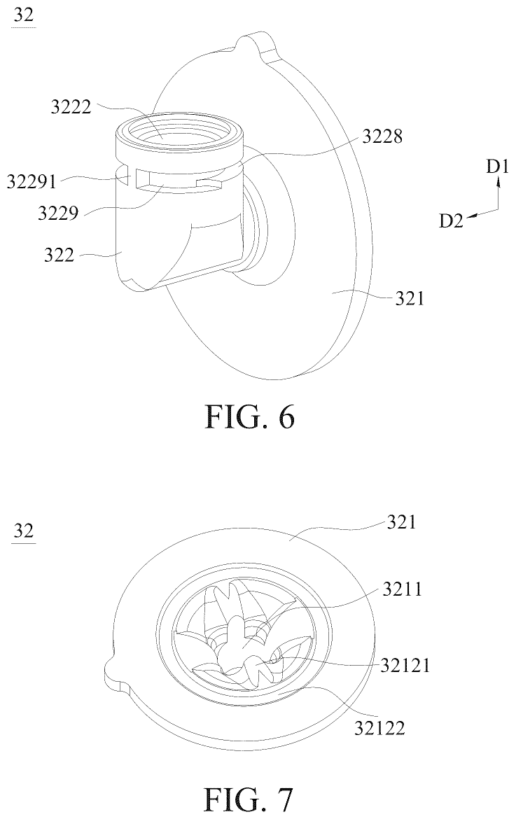

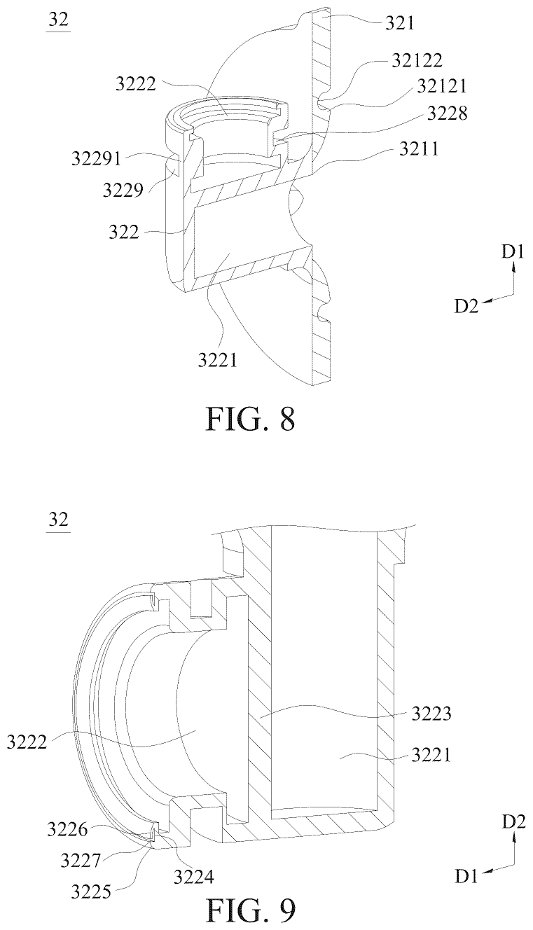

Refer to FIG. 2 to FIG. 4 in conjunction with FIG. 6 to FIG. 9. FIG. 6 is a schematic diagram of an appearance of an embodiment of a sealing member of a valve structure of this application; FIG. 7 is a schematic diagram of an embodiment of a sealing member of a valve structure of this application from another perspective; FIG. 8 is a schematic cross-sectional view 1 of an embodiment of a sealing member of a valve structure of this application; and FIG. 9 is a schematic cross-sectional view 2 of an embodiment of a sealing member of a valve structure of this application. In some embodiments, the sealing member 32 is made of a flexible material. Herein, the sealing member 32 includes a first portion 321 and a second portion 322 that are connected to each other. The first portion 321 has a sheet structure. The second portion 322 has a hollow block structure. In these embodiments, the first portion 321 is located between the valve cover 12 and the valve body 11. The second portion 322 can be deformed relative to the first portion 321. The second end 312 of the link 31 passes through the first portion 321 and is inserted into the second portion 322. Accordingly, when the driving member 21 drives the link 31 to swing, the link 31 drives the second portion 322 of the sealing member 32 to deform relative to the first portion 321, so as to move away from or abut against the valve outlet 1133 of the valve body 11.

Refer to FIG. 6 to FIG. 11. In some embodiments, the body portion 112 of the valve body 11 has a positioning edge 1122. The positioning edge 1122 protrudes from a surface of the body portion 112 of the valve body 11 close to the valve opening 114. An outer surface of the positioning edge 1122 is rectangular. The positioning edge 1122 has a first-section inner surface 11221 and a second-section inner surface 11222. The first-section inner surface 11221 is close to the valve opening 114. The second-section inner surface 11222 is joined to the first-section inner surface 11221. In these embodiments, an inner peripheral contour of the first-section inner surface 11221 corresponds to an outer peripheral contour of the first portion 321 of the sealing member 32, and shapes of the inner peripheral contour of the first-section inner surface 11221 and the outer peripheral contour of the first portion 321 of the sealing member 32 are non-circular. Accordingly, when the first portion 321 of the sealing member 32 is located between the valve body 11 and the valve cover 12, the sealing member 32 is accommodated between the first-section inner surface 11221 of the positioning edge 1122, and is also restricted from rotation due to its appearance shape, thereby ensuring the sealing member 32 can be stably deformed when subjected to force, and ensuring the opening and closing effect of the valve body 11.

Refer to FIG. 2 to FIG. 4 and FIG. 6 to FIG. 9. In some embodiments, the first portion 321 of the sealing member 32 has a through hole 3211 and an upper surface 3212 and a lower surface 3213 that are opposite to each other. The through hole 3211 extends through the upper surface 3212 and the lower surface 3213. The lower surface 3213 is a plane. The upper surface 3212 has an arc-shaped convex portion 32121 and an annular concave portion 32122. The annular concave portion 32122 surrounds the through hole 3211. The annular concave portion 32122 surrounds the arc-shaped convex portion 32121. In these embodiments, an end surface of the arc-shaped convex portion 32121 away from the lower surface 3213 is an arc surface. Accordingly, when the sealing member 32 is arranged between the valve body 11 and the valve cover 12, the sealing member 32 abuts against the valve body 11 through the lower surface 3213 of the first portion 321, and abuts against the valve cover 12 through the upper surface 3212. Accordingly, the valve cover 12 abuts against the arc-shaped convex portion 32121 of the upper surface 3212 of the first portion 321 of the sealing member 32. In this way, a contact area between the valve cover 12 and the sealing member 32 is reduced to prevent the sealing member 32 from being pressed tightly and affecting the deformation of the second portion 322, and ensure that the second portion 322 can be deformed by force to complete the opening and closing of the valve body 11.

Refer to FIG. 2 to FIG. 4 and FIG. 6 to FIG. 9. In some embodiments, the second portion 322 of the sealing member 32 includes a first groove 3221, a second groove 3222, and a spacing wall 3223. The first groove 3221 is formed along the second direction D2, the second groove 3222 is formed along the first direction D1, and the spacing wall 3223 is located between the first groove 3221 and the second groove 3222. In these embodiments, an inner peripheral contour of the first groove 3221 corresponds to a shape of the second end 312 of the link 31, so that the second end 312 of the link 31 can be inserted into the first groove 3221 of the sealing member 32 and can reliably apply a force to the sealing member 32 to drive the sealing member 32 to deform.

Refer to FIG. 2 to FIG. 9. In some embodiments in which the second end 312 of the link 31 is cylindrical, the first groove 3221 has a first inner surface 32211. The second groove 3222 has a second inner surface 32221. The first inner surface 32211 becomes circular around the second direction D2. The second inner surface 32221 becomes circular around the first direction D1. Accordingly, the first groove 3221 can be tightly engaged with the second end 312 of the link 31, and the second groove 3222 can improve elasticity of the sealing member 32 to absorb the force of the sealing member 32 when impacting and closing the valve outlet 1133, reduce wear of the sealing member 32, and ensure a sealing effect of the sealing member 32 on the valve outlet 1133.

Refer to FIG. 2 to FIG. 4 and FIG. 6 to FIG. 9. In some embodiments, the second portion 322 of the sealing member 32 further includes an end surface 3224, a first flange 3225, a second flange 3226, and a ring groove 3227. The end surface 3224 surrounds an end of the second groove 3222 away from the spacing wall 3223. The first flange 3225 protrudes from the end surface 3224 and is located on an end of the end surface 3224 away from the second groove 3222. The second flange 3226 protrudes from the end surface 3224 and is located on an end of the end surface 3224 adjacent to the second groove 3222. The ring groove 3227 is defined between the first flange 3225 and the second flange 3226. Accordingly, when the sealing member 32 closes the valve outlet 1133, the sealing member 32 abuts against a periphery of the valve outlet 1133 through the end surface 3224, the first flange 3225 and the second flange 3226 can provide a double-layer leak-proof effect, and the ring groove 3227 can block the flow of fluid, thereby effectively improving the leak-proof effect.

In some embodiments in which the sealing member 32 includes a first flange 3225 and a second flange 3226, a first included angle is formed at a joint between the first flange 3225 and the ring groove 3227, a second included angle is formed at a joint between the second flange 3226 and the ring groove 3227, and the first included angle is greater than the second included angle. Accordingly, when the first flange 3225 fails to prevent leakage, the second flange 3226 can effectively block the flow of fluid, providing the double-layer leak-proof effect.

Refer to FIG. 2 to FIG. 4 and FIG. 6 to FIG. 9. In some embodiments, the second flange 3226 includes a joining section 32261 and an extending section 32262. The joining section 32261 is joined to the ring groove 3227, and a length of the extending section 32262 overlapping the ring groove 3227 in the second direction D2 is greater than 50% of a total length of the ring groove 3227 in the second direction D2. Accordingly, the end of the second flange 3226 extending into the ring groove 3227 can more flexible and elastic, and can be more tightly attached around the valve outlet 1133, thereby improving the leak-proof effect.

Refer to FIG. 2 to FIG. 4 and FIG. 6 to FIG. 9. In some embodiments, an outer contour of a part of the first portion 321 of the sealing member 32 is generally circular. Herein, the circular outer contour of the part of the first portion 321 of the sealing member 32 has a center of a circle. The first groove 3221 of the second portion 322 has an axis. The axis passes through the center of a circle of the first portion 321. In addition, a part of the second portion 322 of the sealing member 32 provided with the second groove 3222 is located on one side of a part of the second portion 322 provided with the first groove 3221. In the position in the first direction D1, the center of a circle of the first portion 321 does not overlap with the part of the second portion 322 provided with the second groove 3222. In these embodiments, when the sealing member 32 is sleeved on the link 31 in the flow channel P, the part of the second portion 322 of the sealing member 32 provided with the second groove 3222 can be closer to the fluid outlet 1132 than the part of the second portion 322 provided with the first groove 3221. Accordingly, when the sealing member 32 is in an open state, a distance between the end surface 3224 of the sealing member 32 and the valve outlet 1133 can be shortened, and a reaction speed of the sealing member 32 can be increased. In addition, a space between a side of the sealing member 32 provided with the first groove 3221 and the valve inlet 1113 is expanded, to reduce resistance of fluid entering the valve body 11 and the required driving force, thereby better meeting the energy-saving effect.

Refer to FIG. 2 to FIG. 4 and FIG. 6 to FIG. 9. In some embodiments, the second portion 322 of the sealing member 32 has a part of the second groove 3222 formed into a cylinder around the first direction D1, and an outer peripheral surface of the part of the second portion 322 further includes a first notch 3228 and a second notch 3229. In the second direction D2, the first notch 3228 is closer to the valve cover 12 than the second notch 3229, and the first notch 3228 has a first groove width in the first direction D1. The second notch 3229 has a second groove width in the first direction D1. The first groove width may, but is not limited to, be equal to or not equal to the second groove width. This allows for adjustment of the elasticity of different positions of the part of the sealing member 32 provided with the second groove 3222. In some embodiments, the first groove width is less than the second groove width. Accordingly, when the link 31 drives the sealing member 32 to swing and abut against the periphery of the valve outlet 1133, a side of the sealing member 32 with the second notch 3229 contacts the periphery of the valve outlet 1133 and bears a greater force. Herein, a side of the sealing member 32 provided with the second notch 3229 can provide a relatively large deformation space for the sealing member 32, thereby balancing the stress acting on the contact surface when the sealing member 32 abuts against the periphery of the valve outlet 1133. Under the condition that the stress on the contact surface when the sealing member 32 abuts against the periphery of the valve outlet 1133 is balanced, unilateral wear of the sealing member 32 is reduced, and the durability and service life of the sealing member 32 are prolonged.

Refer to FIG. 2 to FIG. 4 and FIG. 6 to FIG. 9. In some embodiments, the second portion 322 of the sealing member 32 further includes a reinforcing rib 32291. The reinforcing rib 32291 is arranged in the second notch 3229, thereby locally increasing the strength of the second portion 322 having the second notch 3229. In this way, when the driving member 21 of the link 31 moves from the first position L1 to the second position L2, and a self-closing position of the sealing member 32 is to be separated from the valve outlet 1133, the part of the second portion 322 of the sealing member 32 provided with the second notch 3229 can have relatively high strength, and can be smoothly driven away from the valve outlet 1133 when the link 31 drives the sealing member 32, thereby reducing the force required for the driving assembly 20 to drive the linkage assembly 30 to open the valve outlet 1133, and achieving the labor-saving effect of opening the valve body 11.

It is worth noting that the second portion 322 of the sealing member 32 may not be provided with the second groove 3222 (that is, the second groove 3222 is provided as a solid structure), and to adjust the elasticity of the sealing member 32 or apply different processing methods, the elasticity provided by providing the second groove 3222 may be replaced by increasing quantities of first notches 3228 and second notches 3229 on a local outer surface provided with the second groove 3222, but the present disclosure is not limited thereto.

Refer to FIG. 3. In another embodiment, the second groove 3222, the first notch 3228, and the second notch 3229 may also be provided on the second portion 322 of the sealing member 32, and even an inner ring groove 32222 may also be provided on the second inner surface 32221 of the second groove 3222, so that the second portion 322 of the sealing member 32 can have different elastic characteristics. In other words, the sealing member 32 may be provided with one or a combination of the second groove 3222, the first notch 3228, the second notch 3229, or the inner ring groove 32222 of the second inner surface 32221. This allows for adjustments to achieve different elastic characteristics to meet different requirements.

Refer to FIG. 2 to FIG. 4. In some embodiments, the valve structure is driven by air pressure to move the driving assembly 20 along the second direction D2. In these embodiments, a spring 40 is sleeved on a part of the driving member 21 and accommodated in the first housing 13, and the part extends out of the first housing 13 and is accommodated in the second housing 14. A sliding block movable along the second direction D2 is arranged in the second housing 14 and connected to the part of the driving member 21 in the second housing 14. The second housing 14 has a second air inlet 141. Accordingly, when a driving gas is supplied from an air pressure source through the second air inlet 141, the driving gas pushes the sliding block away from the first housing 13, the sliding block drives the driving member 21 to move from the first position L1 to the second position L2, and compresses the spring 40 at the same time to store elastic force. And when the supply of the driving gas from the second air inlet 141 is stopped, the spring 40 releases the elastic force to drive the driving member 21 to return from the second position L2 to the first position L1.

In some embodiments, since the spring 40 is mostly made of a metal material, to prevent the spring 40 made of the metal material in the valve structure from having an adverse effect on the manufacturing process using the valve structure, in some embodiments, the spring 40 may not be sleeved on the driving member 21, and the first housing 13 has the first air inlet 131. Accordingly, when the driving gas is supplied from the air pressure source through the first air inlet 131, the driving gas pushes the driving member 21 away from the second housing 14, and the driving member 21 is moved from the second position L2 to the first position L1, so as to complete the driving of the driving member 21.

It is worth noting that in the foregoing embodiment, an example in which the driving assembly 20 of the valve structure is driven by the air pressure is used for description. In another embodiment, the valve structure may not be limited to driving the driving assembly 20 to move by the air pressure. For example, the driving assembly 20 of the valve structure may be manually driven.

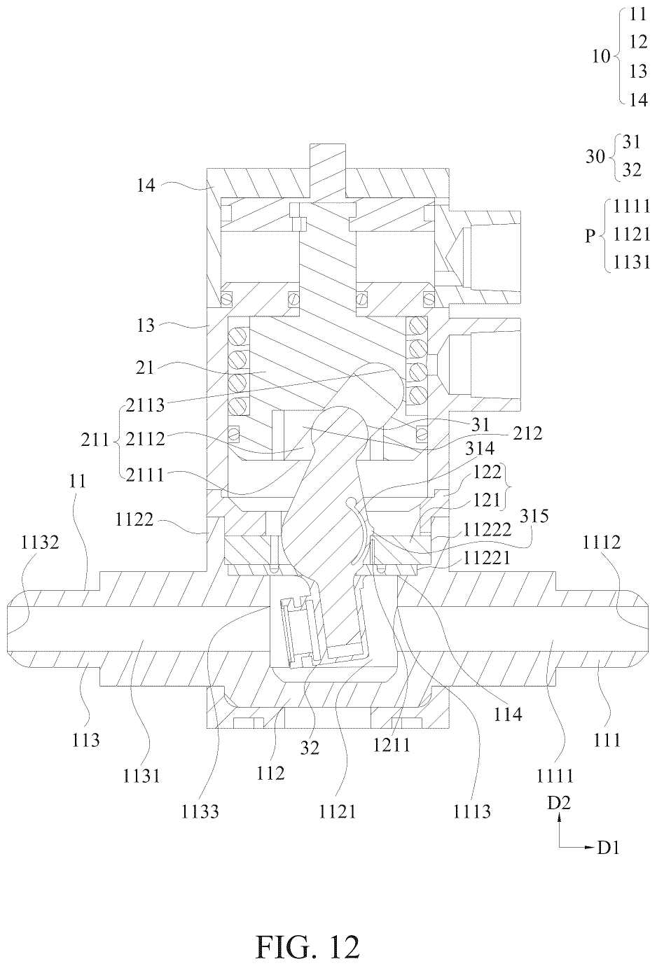

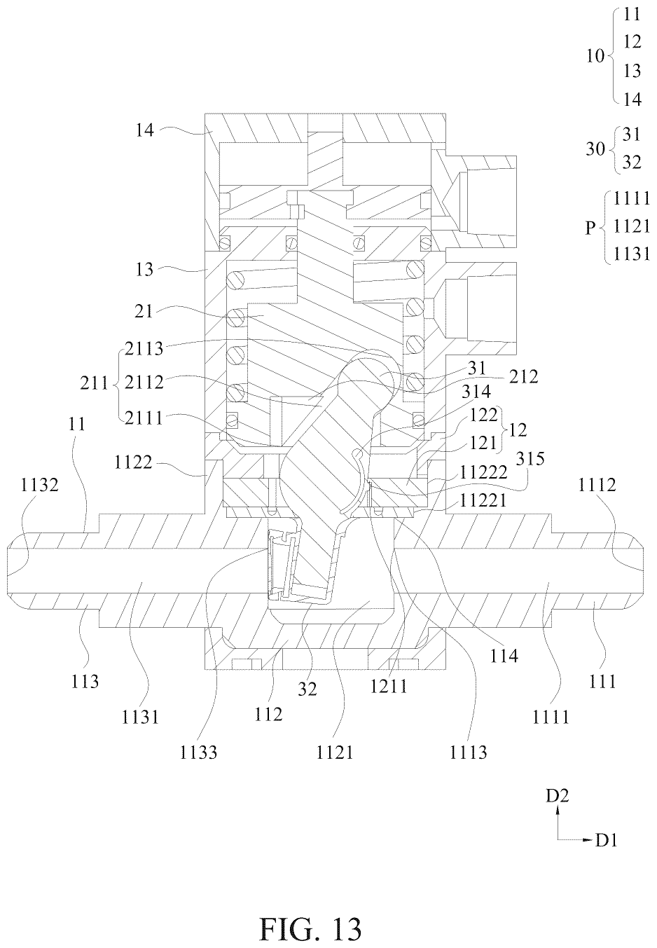

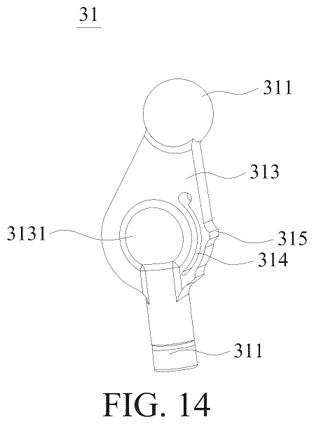

Refer to FIG. 12 to FIG. 14. FIG. 12 is a schematic cross-sectional view of a driving member of another embodiment of a valve structure of this application in a first position; FIG. 13 is a schematic cross-sectional view of a driving member of another embodiment of a valve structure of this application in a second position; and FIG. 14 is a schematic diagram of another embodiment of a link of a valve structure of this application. In some embodiments, a link 31 further includes a notch 314 and a first stop portion 315. The notch 314 is located on a side of a spherical protrusion 3131. The first stop portion 315 is located on a side of the notch 314. In these embodiments, the valve cover 12 includes a first component 121 and a second component 122. The first component 121 has a second stop portion 1211. Positions of the first stop portion 315 and the second stop portion 1211 overlap in a first direction D1. In this way, when the driving member 21 is moved from a first position L1 to a second position L2, or moved from the second position L2 to the first position L1, a first stop portion 315 of the link 31 is to contact the second stop portion 1211 of the valve cover 12, and when the first stop portion 315 contacts the second stop portion 1211, a position of the link 31 corresponding to the first stop portion 315 is compressed and deformed toward the notch 314. Accordingly, the link 31 can absorb the acting force generated during swinging of the link 31 through deformation, thereby slowing down a swinging speed of the link 31, reducing impact of a water hammer effect caused by fluid pressure on the sealing member 32, lowering the noise generated when the valve structure is opened and closed, reducing the wear of the sealing member 32, and prolonging the service life of the valve structure.

Refer to FIG. 10 and FIG. 11. In some embodiments, a position where the main flow channel space 1121 of the body portion 112 of the valve body 11 is joined to the first channel 1111 is in a curved and expanded shape. Specifically, the main flow channel space 1121 is formed by the valve opening 114 extending along the second direction D2. In these embodiments, the valve opening 114 is generally in a shape of an arch, and a range of the main flow channel space 1121 can be defined by a plane 11211 and an arc-shaped surface 11212. The arc-shaped surface 11212 is in a shape of a circular arch, and two ends of the arc-shaped surface 11212 are joined to two ends of the plane 11211. Herein, the valve outlet 1133 is provided on the plane 11211. The valve inlet 1113 is provided on the arc-shaped surface 11212, and a distance between the fluid outlet 1132 and the valve outlet 1133 in the first direction D1 is greater than a distance between the valve inlet 1113 and the fluid inlet 1112 in the first direction D1. In this way, the main flow channel space 1121 is in a curved and expanded shape on a side of the valve inlet 1113. Accordingly, flow resistance of the fluid entering the main flow channel space 1121 through the first channel 1111 can be reduced, and the driving force driving the driving assembly 20 to move can be reduced. In addition, due to the expansion pattern in the position where the main flow channel space 1121 is joined to the first channel 1111, the link 31 is allowed to increase its swing amplitude, thereby increasing smoothness of the fluid flow when the valve body 11 is in the open state.

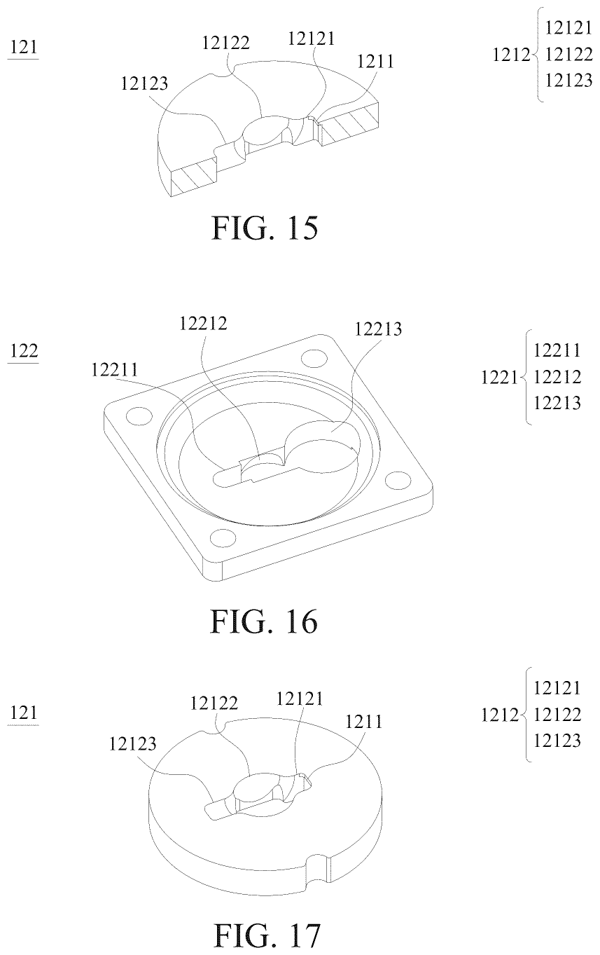

Refer to FIG. 15 to FIG. 17. FIG. 15 is a three-dimensional schematic cross-sectional view of an embodiment of a first component of a valve cover of this application; FIG. 16 is a three-dimensional schematic cross-sectional view of an embodiment of a second component of a valve cover of this application; and FIG. 17 is a schematic diagram of an appearance of an embodiment of a first component of a valve cover of this application. In some embodiments, a first component 121 of a valve cover 12 has a first passage opening 1212. The first passage opening 1212 extends through the first component 121 and includes a first side opening 12121, a first sleeve opening 12122, and a second side opening 12123 that are in communication in sequence. The first sleeve opening 12122 includes two opposite arc contours. The first side opening 12121 and the second side opening 12123 extend straight along two opposite sides of the first sleeve opening 12122 to form rectangular openings. In these embodiments, a spherical protrusion 3131 of a link 31 rotatably abuts against the first sleeve opening 12122, and the first side opening 12121 and the second side opening 12123 provide a space for the link 31 to swing in both directions. In these embodiments, a second stop portion 1211 is a protrusion structure that protrudes into the first passage opening 1212 from an edge of the first side opening 12121.

In some embodiments, the second component 122 of the valve cover 12 has a second passage opening 1221. The second passage opening extends through the second component 122 and includes a limiting opening 12211, a second sleeve opening 12212, and an expansion opening 12213 that are in communication in sequence. The second sleeve opening 12212 includes two opposite arc contours. An appearance contour of the limiting opening 12211 corresponds to a cross-sectional shape of a connecting portion 313 of the link 31, and the expansion opening 12213 expands relative to the limiting opening 12211. In these embodiments, the spherical protrusion 3131 of the link 31 rotatably abuts against the second sleeve opening 12212. The limiting opening 12211 limits a range of rotation of the link 31. The expansion opening 12213 provides an expansion space for the rotation of the link 31, thereby limiting a rotation direction and range of the link 31, so that the link 31 can rotate within the defined direction and range. In these embodiments, the first sleeve opening 12122 of the first component 121 and the second sleeve opening 12212 of the second component 122 define an accommodating groove for accommodating the spherical protrusion 3131.

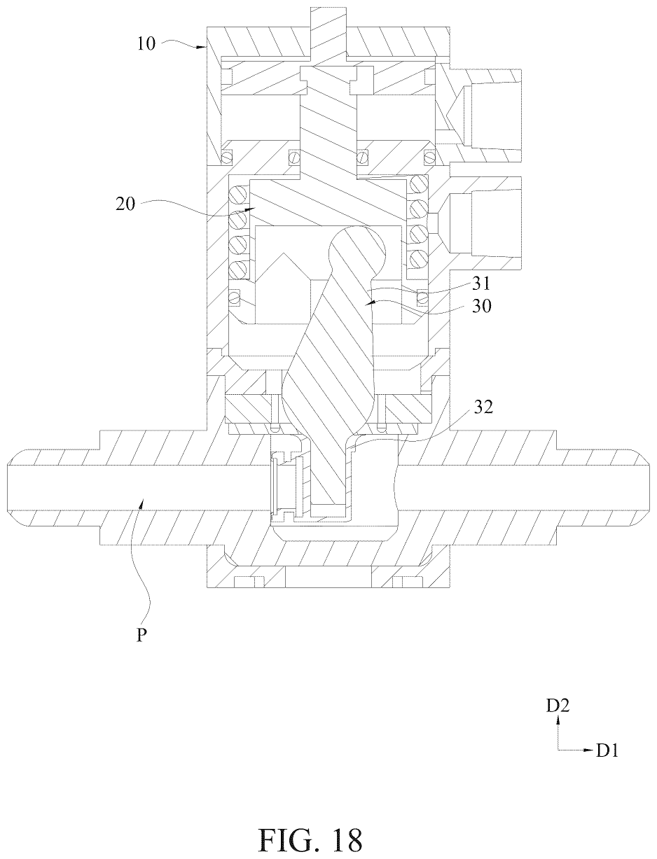

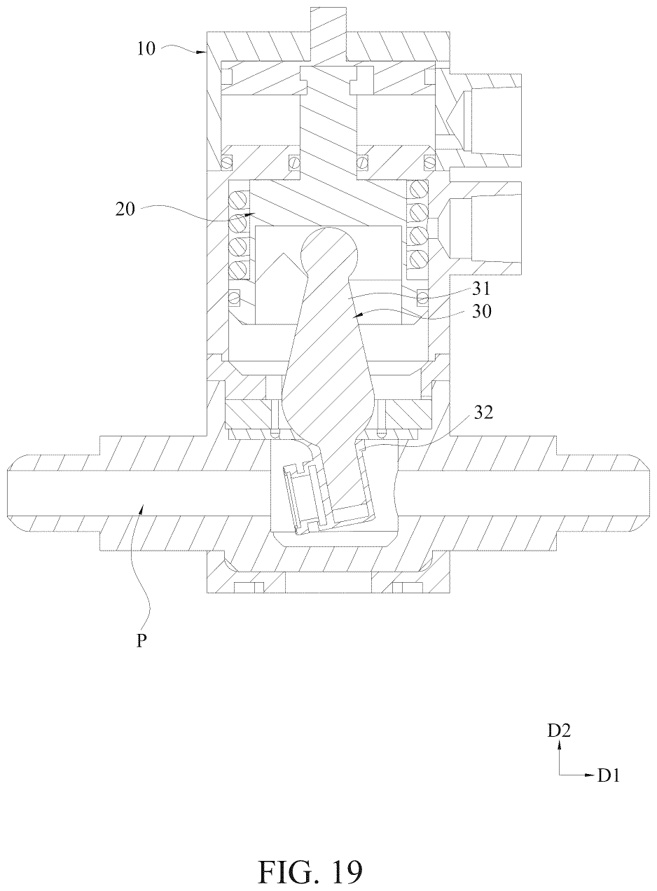

Refer to FIG. 18 and FIG. 19. FIG. 18 is a schematic diagram of an embodiment in which a driving portion of a valve structure of this application extends along a first direction and a linkage assembly closes a flow channel; and FIG. 19 is a schematic diagram of an embodiment in which a driving portion of a valve structure of this application extends along a first direction and a linkage assembly is open relative to a flow channel. In some embodiments, a driving portion 211 of a driving member 21 of a driving assembly 20 may also extend along a first direction D1. To be specific, an included angle of 90 degrees is formed between the driving portion 211 and the second direction D2. In these embodiments, an axial extension direction of a second end 312 of a link 31 does not pass through a center of a circle of a first end 311. Accordingly, the link 31 in the driving portion 211 can also be driven through the driving assembly 20 moving along the second direction D2 to swing to open and close a flow channel P.

What is claimed is:

1. A valve structure, comprising:
a housing assembly, having an internal space, a flow channel, a fluid inlet, a fluid outlet, and a valve cover, wherein the flow channel extends along a first direction and is in communication with the internal space, the fluid inlet extends through the housing assembly and is joined to one end of the flow channel, the fluid outlet extends through the housing assembly and is joined to the other end of the flow channel, and the valve cover is located between the internal space and the flow channel and has an accommodating groove;
a driving assembly, movably arranged in the internal space of the housing assembly along a second direction perpendicular to the first direction, wherein the driving assembly has a driving portion, and an included angle is formed between an extension direction of the driving portion and the second direction; and
a linkage assembly, comprising:
a link, comprising a first end and a second end opposite to each other and a spherical protrusion located between the first end and the second end, wherein the first end is movably accommodated in the driving portion, the spherical protrusion is rotatably accommodated in the accommodating groove, and the second end extends into the flow channel through the valve cover; and
a sealing member, sleeved on the second end of the link, wherein
when the driving assembly moves along the second direction, the driving assembly drives, through the driving portion, the first end of the link to move in the first direction, and the second end is configured to drive the sealing member to open or close the flow channel.

2. The valve structure according to claim 1, wherein the first end of the link is spherical.

3. The valve structure according to claim 1, wherein the housing assembly comprises a valve body, the fluid inlet and the fluid outlet extend through the valve body, the flow channel is located in the valve body, the valve body further comprises a valve opening, the valve opening is in communication with the flow channel, the valve cover covers the valve opening, the sealing member comprises a first portion and a second portion that are connected to each other, the first portion is located between the valve cover and the valve body, the second portion is deformable relative to the first portion, and the second end of the link passes through the first portion and is inserted into the second portion.

4. The valve structure according to claim 3, wherein the second portion of the sealing member comprises a first groove, a second groove, and a spacing wall, the first groove is formed along the second direction, the second groove is formed along the first direction, and the spacing wall is located between the first groove and the second groove.

5. The valve structure according to claim 4, wherein the first groove has a first inner surface, the second groove has a second inner surface, the first inner surface becomes circular around the second direction, and the second inner surface becomes circular around the first direction.

6. The valve structure according to claim 5, wherein the second portion has a part of the second groove formed into a cylinder around the first direction, an outer circumferential surface of the part of the second portion comprises a first notch and a second notch, in the second direction, the first notch is closer to the valve cover than the second notch, the first notch has a first groove width in the first direction, the second notch has a second groove width in the first direction, and the first groove width is not equal to the second groove width.

7. The valve structure according to claim 6, wherein the first groove width is less than the second groove width.

8. The valve structure according to claim 4, wherein the second portion of the sealing member further comprises an end surface, a first flange, a second flange, and a ring groove, the end surface surrounds an end of the second groove away from the spacing wall, the first flange protrudes from the end surface and is located on an end of the end surface away from the second groove, the second flange protrudes from the end surface and is located on an end of the end surface adjacent to the second groove, and the ring groove is defined between the first flange and the second flange.

9. The valve structure according to claim 8, wherein a first included angle is formed at a joint between the first flange and the ring groove, a second included angle is formed at a joint between the second flange and the ring groove, and the first included angle is greater than the second included angle.

10. The valve structure according to claim 8, wherein the second flange comprises a joining section and an extending section, the joining section is joined to the ring groove, and a length of the extending section overlapping the ring groove in the second direction is greater than 50% of a total length of the ring groove in the second direction.

11. The valve structure according to claim 3, wherein the first portion of the sealing member has a through hole and an upper surface and a lower surface that are opposite to each other, the lower surface is a plane, the upper surface has an arc-shaped convex portion and an annular concave portion, the arc-shaped convex portion surrounds the through hole, and the annular concave portion surrounds the arc-shaped convex portion.

12. The valve structure according to claim 1, wherein the link further comprises a notch and a first stop portion, the notch is located on a side of the spherical protrusion, the first stop portion is located on a side of the notch, the valve cover comprises a first component and a second component, the first component has a second stop portion, and positions of the first stop portion and the second stop portion overlap in the first direction.

13. The valve structure according to claim 1, wherein the driving assembly further comprises a relief portion, and the relief portion is joined to the driving portion and extends along the first direction.

14. The valve structure according to claim 1, wherein an included angle is formed between the extension direction of the driving portion of the driving assembly and each of the first direction and the second direction.

15. The valve structure according to claim 1, wherein the driving portion of the driving assembly extends along the first direction.

16. The valve structure according to claim 3, wherein the valve body comprises an inlet pipe portion, a body portion, and an outlet pipe portion that are joined in sequence, the inlet pipe portion has a first channel, the body portion has a main flow channel space, and a position where the main flow channel space is joined to the first channel is in a curved and expanded shape.

17. The valve structure according to claim 5, wherein the second portion of the sealing member further comprises an inner ring groove provided on the second inner surface of the second groove.

18. The valve structure according to claim 6, wherein the second portion of the sealing member further comprises a reinforcing rib, and the reinforcing rib is arranged in the second notch.
